(19) United States
(12) Patent Application Publication
(10) Pub. No.: US 2015/0190016 A1
(43) Pub. Date: Jul. 9, 2015

(54) SINGLE PIECE RESILIENT PLASTIC EGG SEPARATOR IN THE SHAPE OF AN EGG

(71) Applicants: SASHA GOLDBERG, New York, NY (US); SUZANN ZEITEL, New York, NY (US)

(72) Inventors: SASHA GOLDBERG, New York, NY (US); SUZANN ZEITEL, New York, NY (US)

(21) Appl. No.: 14/148,431

(22) Filed: Jan. 6, 2014

(51) Int. Cl. A47J 43/14

(52) U.S. Cl. CPC A47J 43/14

(57) ABSTRACT

The egg separator according to the invention includes a single piece resilient deformable hollow plastic member essentially in the shape and size of a chicken egg. Viewing the egg shaped member as having a longitudinal axis, the bottom (larger end) of the member is truncated essentially perpendicular to the axis thereby creating an opening into the interior of the egg shaped member. The hollow egg shaped member defines a wall separating the exterior and the interior of the member. According to one embodiment, the wall thickness surrounding the opening is approximately 0.59 inch, thereby creating a somewhat cylindrical entrance into the hollow interior of the member. According to a second embodiment the wall thickness surrounding the opening varies, thereby creating a somewhat concave entrance into the hollow interior of the member.

### CROSS-REFERENCE TO RELATED APPLICATIONS

This application is a continuation-in-part of application Ser. No. 13/777,295, filed Feb. 26, 2013, entitled SINGLE PIECE RESILIENT PLASTIC EGG SEPARATOR IN THE SHAPE OF AN EGG which claims benefits from U.S. Provisional Patent Application No. 61/699,827, filed Sep. 11, 2012, the contents of which are both hereby incorporated herein by reference.

### BACKGROUND OF THE INVENTION

1. Field of the Invention

This invention relates broadly to egg separators. More particularly, this invention relates to a device for separating an egg yolk from an egg white.

2. State of the Art

Egg separators, per se, are old in the art. They generally take the form of a bowl of some sort with slots. When an egg shell is broken and the contents transferred to the bowl, the white escapes through the slots leaving the yolk, thereby separating the white from the yolk.

U.S. Pat. No. 7,472,647, issued Jan. 6, 2009 to Patterson discloses an egg separator having an upper elongated slit to prevent the yolk of an egg from entering a collection device for egg whites. The device provides for a method that will allow multiple separations of egg whites from egg yolks upon cracking individual eggs. The presence of an upper elongated slit in the concave compartments of the device allows the egg white of the eggs to separate from the egg yolks without the egg yolk entering a collection device and/or mixing, merging or flowing into the collected egg whites.

U.S. Published Application 20120125210 of Myoung published May 24, 2012 discloses an egg separator similar to that described by Patterson, but with a plurality of slits arranged along the bottom of a bowl. The inventor describes it as follows. An egg separator includes a bowl sized to accommodate at least one egg. The bowl includes sidewalls extending upward, with at least one slit extending in a vertical direction. Most preferably, the slit begins at a lowest portion of the bowl and runs in a vertical direction toward the rim of the bowl. In one version of the invention, three slits are provided, spaced evenly about the perimeter of the bowl. In accordance with some versions of the invention, a clip or retaining mechanism is provided to secure the egg separator to a rim of a mixing bowl. Consequently, the egg separator may be attached in a fixed position such that the bowl of the egg separator may be extended over the mixing bowl, allowing a user to crack an egg and pour it into the egg separator.

Some common characteristics of the prior art egg separators can be summarized as follows. They all rely on gravity to function. The separation must be performed immediately following the breaking of the egg shell. Once a complete egg has been deposited somewhere other than in the egg separator, it is impossible to perform separation. Significantly, and partly as a result of the above, the known egg separators separate the white from the yoke rather than separating the yolk from the white.

### SUMMARY OF THE DISCLOSURE

The egg separator according to the invention includes a single piece resilient deformable hollow plastic member essentially in the shape and size of a chicken egg. As used herein, the term “plastic” is intended to mean malleable, moldable, pliable, pliant, ductile, flexible, soft, workable, bendable, etc. Viewing the egg shaped member as having a longitudinal axis, the bottom (larger end) of the member is truncated essentially perpendicular to the axis thereby creating an opening into the interior of the egg shaped member. According to the first embodiment, the diameter of the opening is approximately 0.87 inch±0.15 inch. According to the second and presently preferred embodiment, the diameter of the opening is approximately 0.74 inch±0.15 inch

The hollow egg shaped member defines a wall separating the exterior and the interior of the member. According to the first embodiment, the wall thickness surrounding the opening is approximately 0.59 inch±0.15 inch, thereby creating a somewhat cylindrical entrance into the hollow interior of the member. According to the second and presently preferred embodiment, the wall thickness surrounding the opening varies, thereby creating a somewhat concave entrance into the hollow interior of the member.

In use, one or more eggs are broken and placed (both whites and yolks) on a surface or in a container. The member is squeezed, thus expelling air from its interior and creating a vacuum therein. The bottom opening of the member is located above an egg yoke and the member is allowed to return to its undeformed state. This causes the vacuum in the interior of the member to be filled with surrounding air and the proximal yoke. The configuration of the entrance to the interior of the member, as well as the size of the opening and the smooth interior of the member act to preserve the integrity of the egg yoke. The member is then located above another surface or container and is deformed by squeezing. This causes the unbroken egg yoke to be expelled from the member.

The present invention provides several advantages over the prior art. It allows the entire egg to be deposited from the shell before it is separated. For example, the prior art requires that the egg be separated as it exits the shell. In some prior art devices, a single user must hold the prior art egg separator in one hand while breaking the egg over it with the other hand. This requires considerable skill.

The egg separator of the invention may be provided in different sizes to accommodate different sized eggs. Presently preferred materials include food grade molded silicone.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of an egg separator according to a first embodiment of the invention;

FIG. 2 is a side elevation view of the egg separator of FIG. 1;

FIG. 3 is a sectional view taken along line A-A in FIG. 2;

FIG. 4 is a top plan view of the egg separator of FIGS. 1-3;

FIG. 5 is a bottom plan view of the egg separator of FIGS. 1-4;

FIG. 6 is a perspective view of the egg separator of FIGS. 1-5 in a first stage of operation;

FIG. 7 is a perspective view of the egg separator of FIGS. 1-6 in second/third stages of operation;

FIG. 8 is a perspective view of the egg separator of FIGS. 1-7 completing the final stage of operation;

FIG. 9 is a perspective view of an egg separator according to a second embodiment of the invention;

FIG. 10 is a side elevation view of the egg separator of FIG. 9;

FIG. 11 is a sectional view taken along line A-A in FIG. 10;

FIG. 12 is a top plan view of the egg separator of FIGS. 9-11;

FIG. 13 is a bottom plan view of the egg separator of FIGS. 9-12;

FIG. 14 is a perspective view of the egg separator of FIGS. 9-13 in a first stage of operation;

FIG. 15 is a perspective view of the egg separator of FIGS. 9-14 in second/third stages of operation; and

FIG. 16 is a perspective view of the egg separator of FIGS. 9-15 completing the final stage of operation.

### DETAILED DESCRIPTION

### First Embodiment

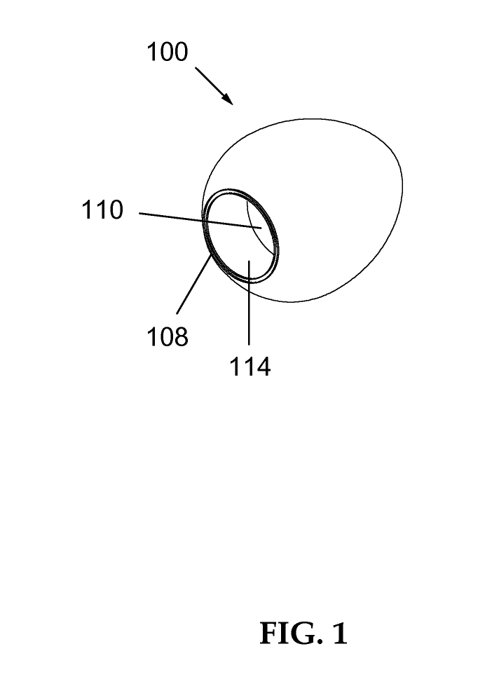

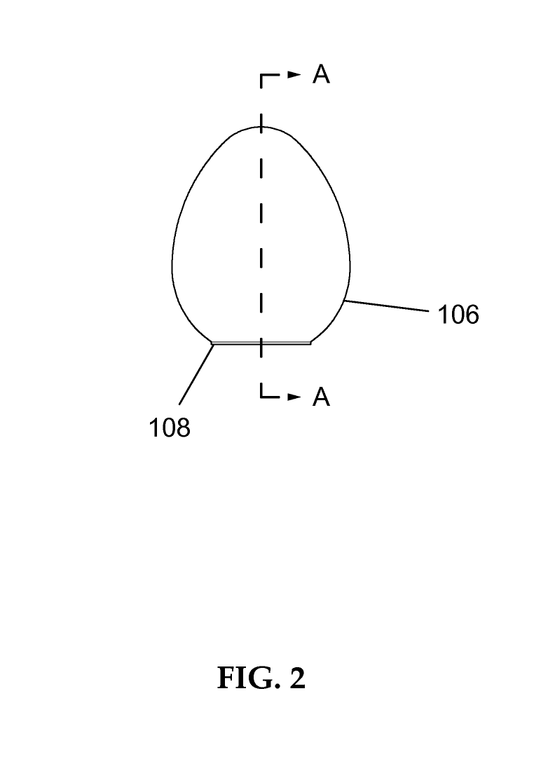

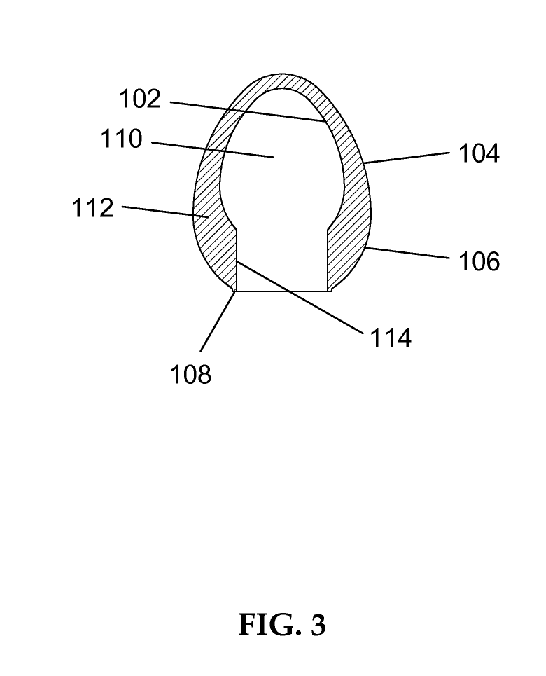

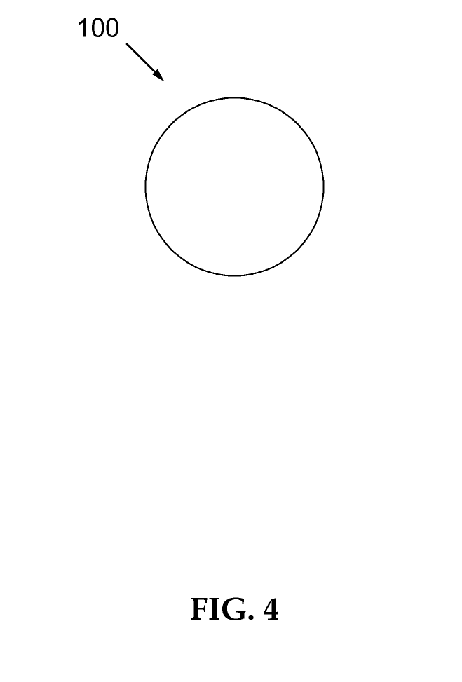

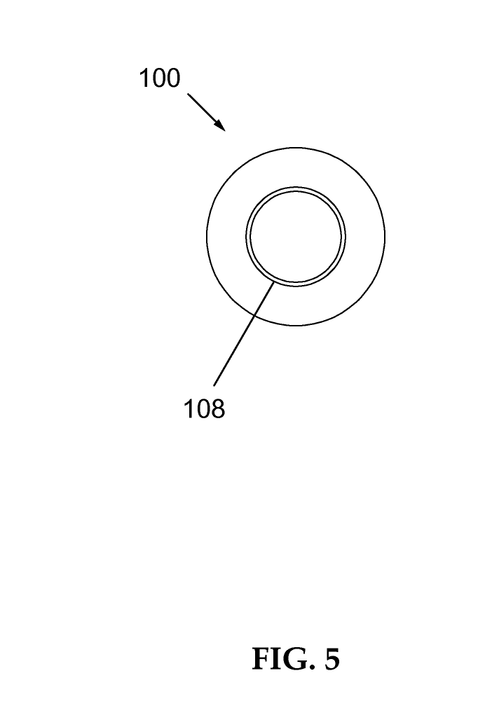

Turning now to FIGS. 1-8, the egg separator 100 according to the first embodiment of the invention includes a single piece resilient deformable hollow plastic member essentially in the shape and size of a chicken egg and defining an inner wall 102 and an outer wall 104. Viewing the egg shaped member as having a longitudinal axis (see FIG. 2, line A-A), the bottom (larger end) 106 of the member is truncated essentially perpendicular to the axis thereby creating an opening 108 into the interior 110 of the egg shaped member 100. According to the preferred first embodiment, the diameter of the opening 108 is approximately 0.87 inch. However, a variance of ±0.15 inch appears to be acceptable.

The inner wall 102 and the outer wall 104 define a wall thickness 112 separating the exterior and the interior of the member 100. According to the preferred first embodiment, the wall thickness surrounding the opening 108 is approximately 0.59 inch±0.15 inch, thereby creating a somewhat cylindrical entrance 114 into the hollow interior 110 of the member 100.

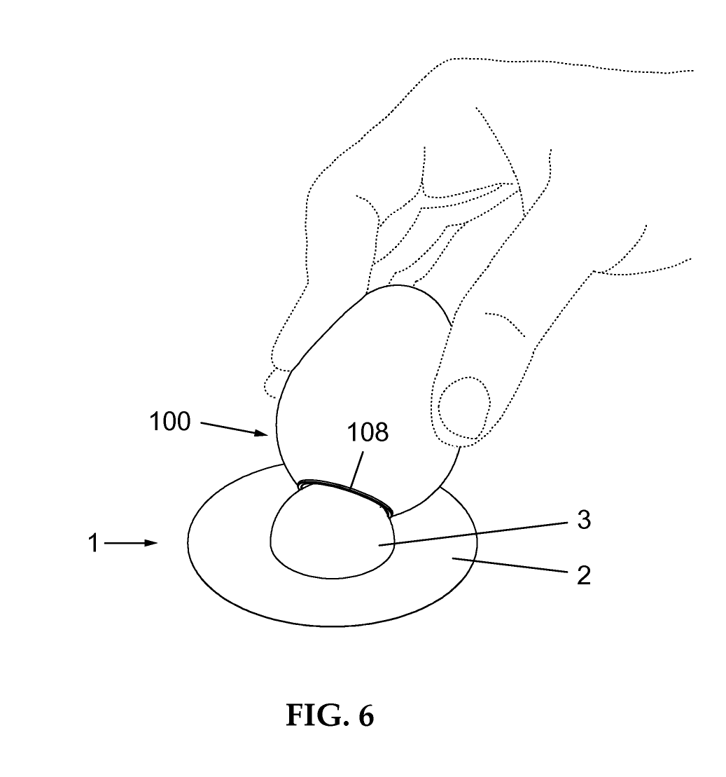

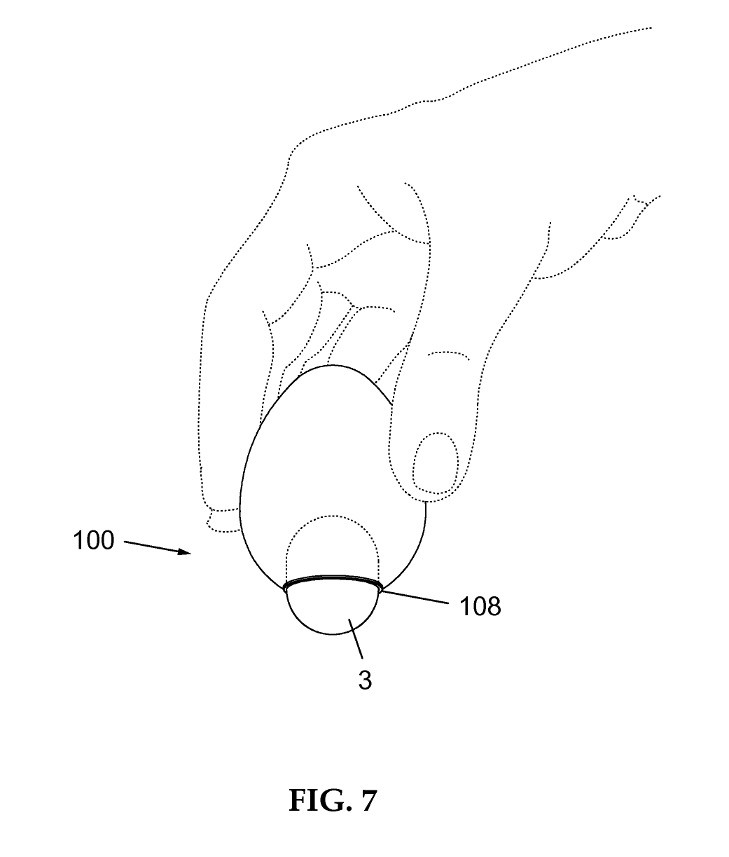

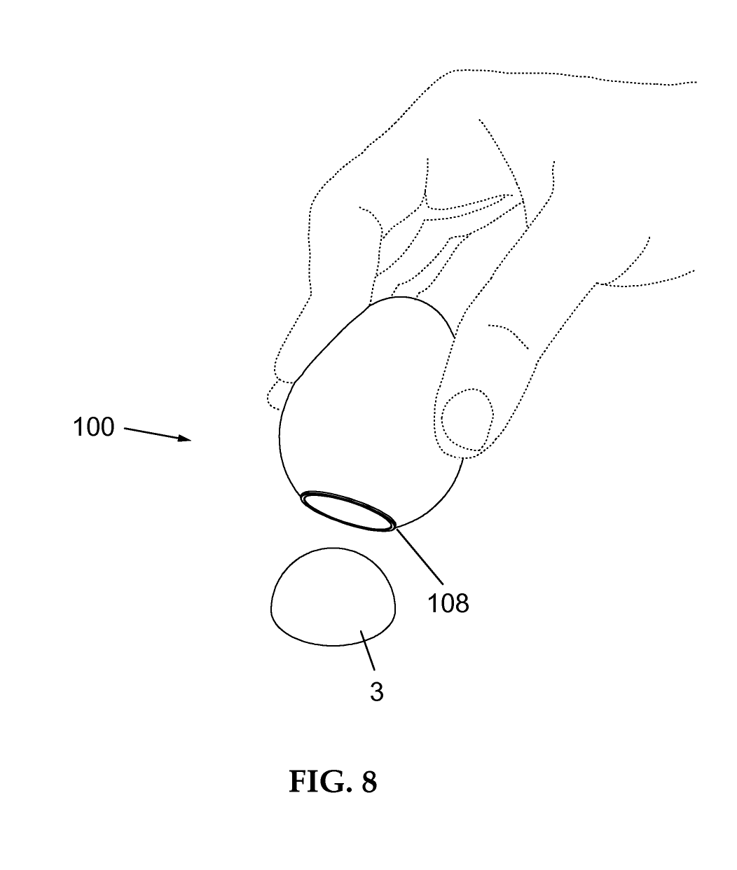

As shown in FIGS. 6-8, in use, one or more eggs 1 are broken and placed (both whites 2 and yolks 3) on a surface or in a container. The member 100 is squeezed, thus expelling air from its interior and creating a vacuum therein. The bottom opening 108 of the member is located above an egg yoke 3 and the member is allowed to return to its undeformed state. This causes the vacuum in the interior of the member 100 to be filled with surrounding air and the proximal yoke 3 as shown in partial stage of completion in FIG. 7. The thickness of the entrance 114 to the interior 110 of the member, as well as the size of the opening 108 and the smooth interior wall 102 of the member act to preserve the integrity of the egg yoke 3. The member 100 is then located above another surface or container and is deformed by squeezing. This causes the unbroken egg yoke to be expelled from the member as shown in partial stage of completion in FIG. 7 and fully completed in FIG. 8.

The egg separator of the first embodiment of the invention may be provided in different sizes to accommodate different sized eggs. Presently preferred materials include food grade molded silicone. However other appropriate materials may be used. According to the presently preferred first embodiments, the invention has an overall height of 2.07 inches±0.25 inch, an overall width of 1.69 inches±0.25 inch, and a wall thickness that varies from 0.28 inch to 0.59 inch±0.15 inch. The thickest part of the wall is that which surrounds the opening. The opening preferably has a diameter of 0.87 inch and a depth of 0.59 inch±0.15 inch.

### Second Embodiment

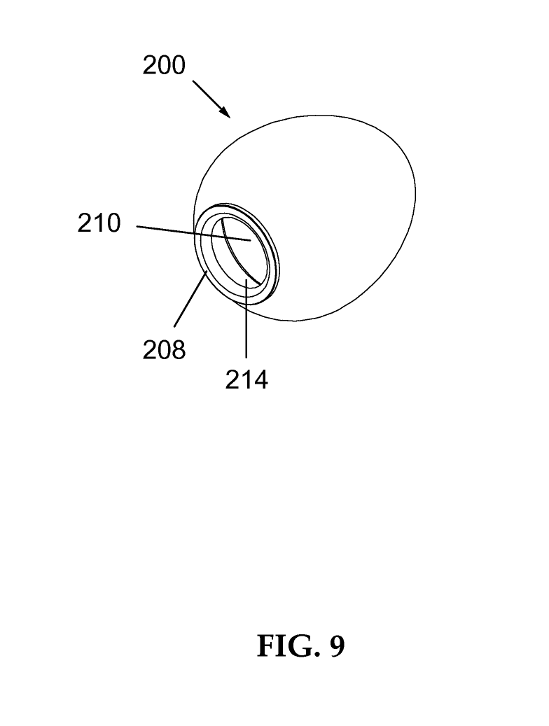

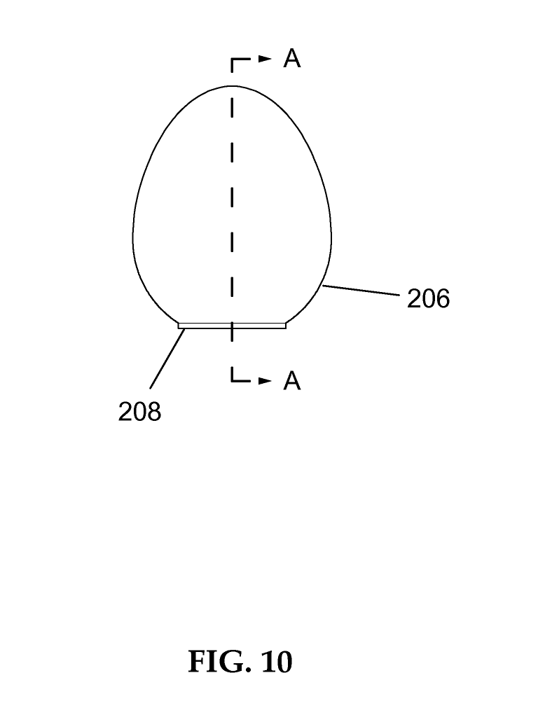

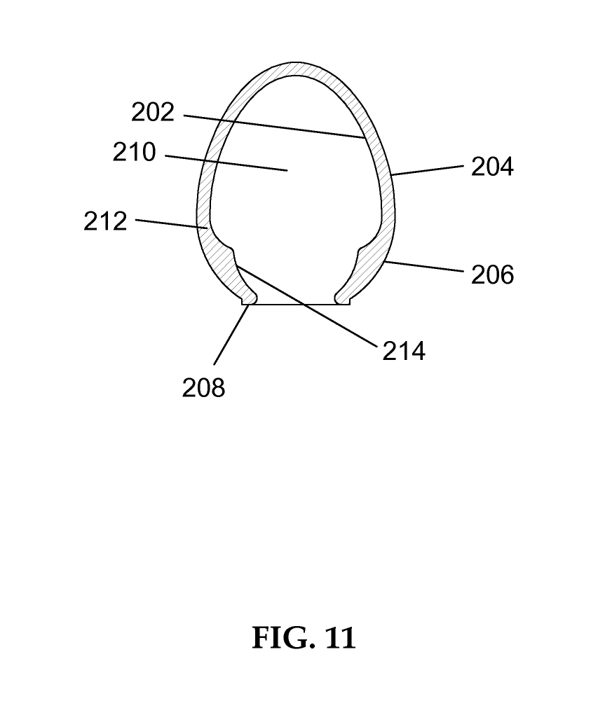

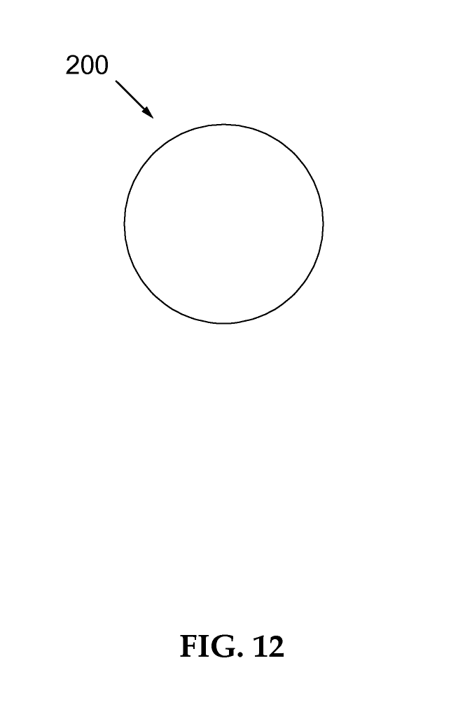

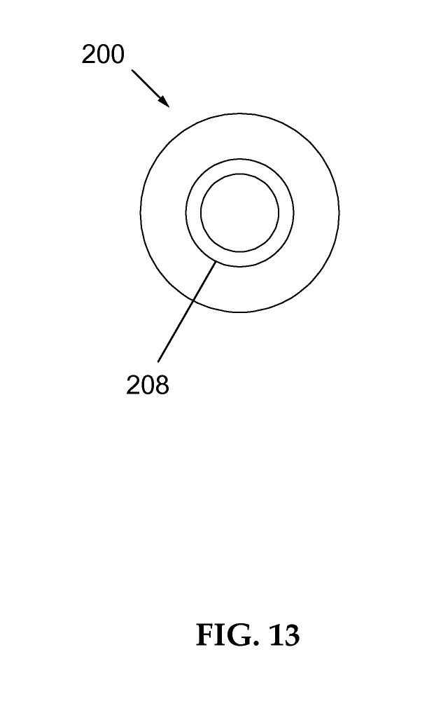

Turning now to FIGS. 9-16, the egg separator 200 according to the invention includes a single piece resilient deformable hollow plastic member essentially in the shape and size of a chicken egg and defining an inner wall 202 and an outer wall 204. Viewing the egg shaped member as having a longitudinal axis (see FIG. 10, line A-A), the bottom (larger end) 206 of the member is truncated essentially perpendicular to the axis thereby creating an opening 208 into the interior 210 of the egg shaped member 200. According to the preferred embodiment, the diameter of the opening 208 is approximately 0.74 inch. However, a variance of ±0.15 inch appears to be acceptable.

The inner wall 202 and the outer wall 204 define a wall thickness 212 separating the exterior and the interior of the member 200. According to the preferred embodiment, the wall thickness surrounding the opening 208 varies (preferably from 0.13 inch to 0.26 inch±0.15 inch), thereby creating a somewhat concave entrance 214 into the hollow interior 210 of the member 200.

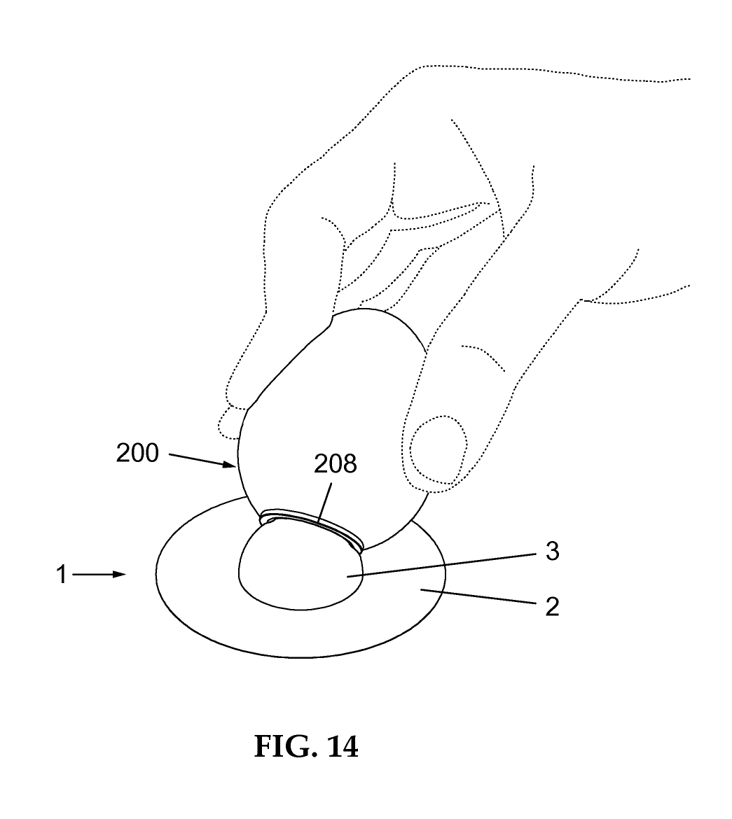

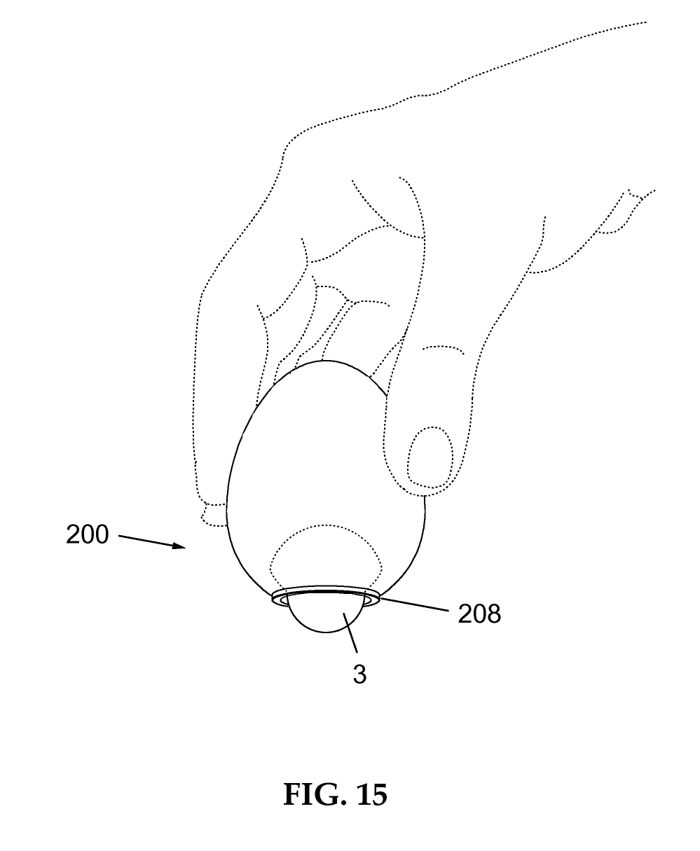

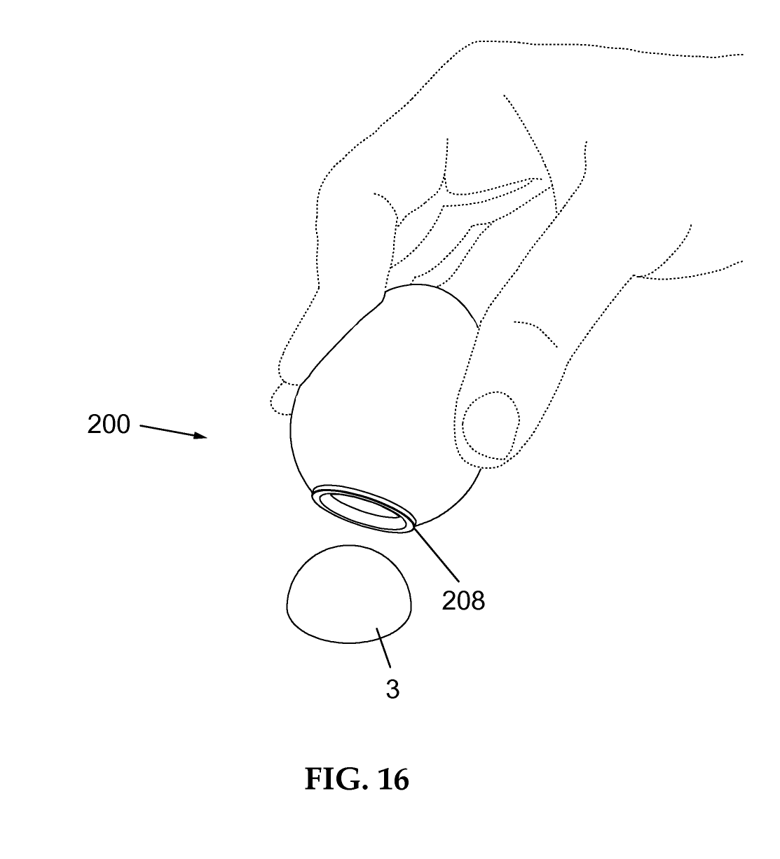

As shown in FIGS. 14-16, in use, one or more eggs 1 are broken and placed (both whites 2 and yolks 3) on a surface or in a container. The member 200 is squeezed, thus expelling air from its interior and creating a vacuum therein. The bottom opening 208 of the member is located above an egg yoke 3 and the member is allowed to return to its undeformed state. This causes the vacuum in the interior of the member 200 to be filled with surrounding air and the proximal yoke 3 as shown in partial stage of completion in FIG. 15. The concave entrance 214 to the interior 210 of the member, as well as the size of the opening 208 and the smooth interior wall 202 of the member act to preserve the integrity of the egg yoke 3. The member 200 is then located above another surface or container and is deformed by squeezing. This causes the unbroken egg yoke to be expelled from the member as shown in partial stage of completion in FIG. 15 and fully completed in FIG. 16.

The egg separator of the invention may be provided in different sizes to accommodate different sized eggs. Presently preferred materials include food grade molded silicone. However other appropriate materials may be used. According to the presently preferred second embodiments, the invention has an overall height of 2.30 inches±0.25 inch, an overall width of 1.89 inches±0.25 inch, and a wall thickness that varies from 0.13 inch to 0.26 inch±0.15 inch. The opening preferably has a diameter of 0.74 inch±0.15 inch.

There have been described and illustrated herein several embodiments of an egg separator and a method of using it. While particular embodiments of the invention have been described, and the second embodiment is presently preferred, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An egg separator, comprising:
a unitary deformable member substantially in the shape of an egg,
said plastic member defining a hollow interior, an internal wall and an external wall,
said internal wall and said external wall defining a wall thickness.
said member further defining an opening into said hollow interior.

2. The egg separator according to claim 1, wherein:
said wall thickness is greater surrounding said opening.

3. The egg separator according to claim 2, wherein:
said opening is substantially circular and said wall thickness surrounding said opening defines a substantially cylindrical entrance to said hollow interior.

4. The egg separator according to claim 1, wherein:
said opening is substantially circular and has a diameter of approximately 0.87 inch±0.15 inch.

5. The egg separator according to claim 3, wherein:
said opening is substantially circular and has a diameter of approximately 0.87 inch±0.15 inch.

6. The egg separator according to claim 3, wherein:
said wall thickness defining said substantially cylindrical entrance is approximately 0.59 inch±0.15 inch.

7. The egg separator according to claim 1, wherein:
said member is made from food grade molded silicone.

8. The egg separator according to claim 1, wherein:
said wall thickness varies around said opening.

9. The egg separator according to claim 1, wherein:
said opening is substantially circular and has a diameter of approximately 0.74 inch±0.15 inch.

10. The egg separator according to claim 8, wherein:
said opening is substantially circular,
said wall thickness surrounding said opening defines a substantially concave entrance to said hollow interior, and
said wall thickness surrounding said substantially concave entrance varies from 0.13 inch to 0.26 inch±0.15 inch.

11. An egg separator, consisting of:
a unitary deformable member substantially in the shape of an egg,
said plastic member defining a hollow interior, an internal wall and an external wall,
said internal wall and said external wall defining a wall thickness.
said member further defining an opening into said hollow interior.

12. The egg separator according to claim 11, wherein:
said wall thickness is greater surrounding said opening.

13. The egg separator according to claim 12, wherein:
said opening is substantially circular and said wall thickness surrounding said opening defines a substantially cylindrical entrance to said hollow interior.

14. The egg separator according to claim 11, wherein:
said opening is substantially circular and has a diameter of approximately 0.87 inch±0.15 inch.

15. The egg separator according to claim 13, wherein:
said opening is substantially circular and has a diameter of approximately 0.87 inch±0.15 inch.

16. The egg separator according to claim 13, wherein:
said wall thickness defining said substantially cylindrical entrance is approximately 0.59 inch±0.15 inch.

17. The egg separator according to claim 11, wherein:
said member is made from food grade molded silicone.

18. The egg separator according to claim 11, wherein:
said wall thickness varies around said opening.

19. The egg separator according to claim 11, wherein:
said opening is substantially circular and has a diameter of approximately 0.74 inch±0.15 inch.

20. The egg separator according to claim 18, wherein:
said opening is substantially circular,
said wall thickness surrounding said opening defines a substantially concave entrance to said hollow interior, and
said wall thickness surrounding said substantially concave entrance varies from 0.13 inch to 0.26 inch±0.15 inch.
